(19) United States
(12) Patent Application Publication
(10) Pub. No.: US 2004/0256048 A1
(43) Pub. Date: Dec. 23, 2004

(54) Disposable nonwoven undergarments and absorbent panel construct

(76) Inventors: Vera Owen, Maumelle, AR (US); Cliff Bridges, Greensboro, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/779,201

(22) Filed: Feb. 13, 2004

Related U.S. Application Data
(60) Provisional application No. 60/447,465, filed on Feb. 14, 2003.
(60) Provisional application No. 60/447,361, filed on Feb. 14, 2003.

(51) Int. Cl. B32B 1/00

(52) U.S. Cl. 156/148; 156/264; 156/209; 156/217

(57) ABSTRACT

The present invention relates to a soft feeling, aesthetically pleasing, and form-fitting disposable nonwoven undergarment for men, women, and youths, and optionally comprises a protective panel for those individuals with mild incontinence conditions.

Most disposable undergarments currently available are awkward, noisy, or comprise unpleasant fasteners. It is the object of the present invention to provide a comfortable, durable disposable undergarment by forming the undergarment of a three-dimensionally imaged nonwoven fabric.

### TECHNICAL BACKGROUND

The present invention relates to a soft feeling, aesthetically pleasing, and form-fitting disposable nonwoven undergarment for men, women, and youths, and may comprise a fluid managing protective panel that helps prevent leaks for those individuals with mild incontinence conditions. The present invention further relates to an absorbent panel construct for use in an absorbent article, and more specifically to an absorbent panel construct that prevents the leakage of human exudates, wherein the absorbent panel comprises an upper layer and a lower layer that remain essentially unattached in a planar orientation so as to form a distinct zone of separation between the upper and lower layers.

### BACKGROUND OF THE INVENTION

Undergarments are those garments that come into direct contact with the skin. They are usually worn under an outer layer of clothing and remain generally unseen by the public. Undergarments cover a variety of constructs such as basic, woven, cotton undershirts and underpants for daily wear, absorbent disposable undergarments such as diapers and incontinence devices used to absorb and retain liquid waste, as well as specialty undergarments such as travel wear, medical wear, and athletic wear.

Disposable undergarments are widely accepted due to the convenience of use, however, such undergarments are often cumbersome, uncomfortable, noisy, and aesthetically unappealing. Prior art discloses disposable undergarments for incontinence purposes, traveling convenience, fem-care products, and medical wear.

Glaug, U.S. Pat. No. 6,307,120 discloses an absorbent incontinence article whereby the absorbent incontinence article is a cloth-like, breathable, disposable, brief comprising plural fastening tapes.

Fell, et al, H1, 969 discloses an absorbent disposable undergarment that utilizes a breathable microporous film as a backing member to improve absorbent and containment characteristics, as well as, to improve comfort for garments such as incontinence devices.

Meisels, U.S. Pat. No. 5,103,501 discloses three articles of disposable underwear for use during travel. The undershirt, men's underpants, and women's underpants, contain magnetic fasteners in order to minimize the amount of dressing time necessary with use of these garments and prevent tearing of the garment during removal.

Greene, U.S. Pat. No. 4,674,135 discloses a durable disposable undergarment that is made of nonwoven cellulosic paper or paper-like material, in which the garment is intended for use by travelers. The disposable garment includes a small bag to be used upon disposal of the garment.

Rajala, et al., U.S. Pat. No. 6,260,211 discloses a disposable undergarment that provides back-up protection for women in the event that a sanitary napkin should leak.

Murakami, et al., U.S. Pat. No. 6,289,519 discloses a disposable, trunk-type, undergarment constructed of a spunbond nonwoven, whereby the trunks are intended for use by medical team members such as doctors and nurses, as well as patients.

The prior art lacks a durable, disposable, nonwoven undergarment that is suitable for daily use. The majority of disposable undergarments are directed toward diapers and incontinence devices or fails to provide the comfort necessary for daily use. Further, for those individuals suffering from a mild incontinence condition, the only available undergarment suitable for use are those of a diaper-like construction, which exhibit a negative aesthetic appeal. In addition, available incontinence devices are designed to withstand a high volume of liquid, which makes the traditional, diaper-like, incontinence device too burdensome. Previously mentioned disposable undergarments are either noisy or contain unpleasant fasteners.

It is the object of the present invention to provide a soft feeling, aesthetically pleasing, and form-fitting disposable undergarment that offers the wearer reassuring comfort. The present invention is durable and intended for daily use, but is also useful in disposable athletic, travel, or medical undergarment, and when so constructed, as a disposable undergarment for mild incontinence conditions.

Typically, absorbent articles, such as diapers and incontinence devices, contain liquid containment barriers that stretch the along the length of the article. These liquid barriers are typically positioned parallel to the leg openings of the article so as to prevent leaking from the leg openings. Such a containment barrier is demonstrated in U.S. Pat. No. 6,503,237, to Andersson, et al., herein incorporated by reference. Although reasonably effective, the liquid containment barriers are usually negatively associated with infant diapers for those individuals who suffer from mild incontinence.

Feminine hygiene articles, such as sanitary napkins, incorporate mechanisms in order to prevent human exudates from leaking through the sides of the article, soiling the protected garment, due to excessive localized insults. Such an article typically comprises a centrally located raised portion that is in direct contact with the user's body, functioning to channel fluids directly into the absorbent core of the article. However, the article does not provide an optimal level of comfort during use, due to the intrusive, and truly uncomfortable nature of the raised portion.

A need remains for less invasive means for preventing human exudates from leaking transversely through the leg openings of the absorbent article or undergarment. The aforementioned mechanisms come in direct contact with the skin compromising the comfort level of the wearer, often rubbing against the skin during the process of use. It is in the purview of the present invention to provide an absorbent panel structure that properly contains human exudates, but also doesn't detract from the comfort level of the absorbent article.

### SUMMARY OF THE INVENTION

The present invention relates to a soft feeling, aesthetically pleasing, and form-fitting disposable nonwoven undergarment for men, women, and youths, and optionally comprises a protective panel for those individuals with mild incontinence conditions.

Most disposable undergarments currently available are awkward, noisy, or comprise unpleasant fasteners. It is the object of the present invention to provide a comfortable, durable disposable undergarment by forming the undergarment of a three-dimensionally imaged nonwoven fabric.

Nonwoven fabrics can be comprised of natural or synthetic fiber, or a combination thereof, which are formed into a web or batt and then bonded or interlocked by means commonly known to one skilled in the art.

Nonwoven fabrics can be processed to exhibit suitable hand, drapeability, and three-dimensional image or pattern to provide for a comfortably fitting, fashionable, disposable undergarment. The present invention discloses an assortment of durable, disposable undergarments capable of meeting the needs of the general public, and specifically, to subsets of the population such as travelers, athletes, medical personnel and patients, for which routine care of conventional undergarments is inconvenient or unavailable.

Individuals with a mild incontinence condition, who require a device suitable for limited urinary containment, may also benefit from an undergarment made in accordance with the present invention. Currently available incontinence undergarments are bulky, and usually resemble the construct of a diaper. The disposable nonwoven undergarment for mild incontinence conditions of the present invention is trim, form fitting, and is equipped with a fluid management panel. In addition, the undergarment is fashionable and comfortable.

The present invention is further directed to an absorbent panel construct that prevents the leakage of human exudates, wherein the absorbent panel comprises an upper layer and a lower layer that remain essentially unattached in a planar orientation so as to form a distinct separation zone between the upper and lower layers.

The absorbent panel construct of the present invention exhibits versatility in its methods of use. In one embodiment, the absorbent panel may be utilized as part of an overall absorbent article or undergarment. For instance, the absorbent panel may be utilized as a topsheet for a disposable hygiene article, such as a diaper, incontinence device, sanitary napkin, or the like.

In a further embodiment, the absorbent panel construct may be a performance enhancing element for a standard undergarment, such as a woven, cotton brief. In this method of use, the absorbent panel is temporarily affixed to the undergarment so as to enhance the absorbency of the undergarment. The absorbent panel may be disposed of after use and replaced as necessary.

Disposable absorbent articles or undergarments are traditionally worn about the torso comprising a front panel, back panel, and interconnecting crotch region. The term “crotch region” used herein refers the region of the absorbent article or undergarment that is positioned between the wears legs so as to adjoin the front and back panels.

In accordance with the present invention, the absorbent panel construct is comprised of an upper layer and a lower layer. Each layer has two longitudinal edges, as well as two transverse edges. The two layers can be further described as having a front region, a back region, and two side regions. The size of absorbent panel is such that it extends beyond the front and back of the crotch region of an absorbent article or undergarment. A distinct separation zone or gap is- formed between the upper layer and lower layer within the crotch region of the absorbent panel due to the two layers being mechanically secured only along the front and back regions of the panel, as well as partially on either side of the panel, however, the portions of the upper and lower layers that are positioned directly within the crotch region remain essentially unattached from one another.

A distinct separation zone can be further described as the void space that is created between the upper and lower layers due to the upper layer remaining essentially free or unattached from the lower layer.

In addition, the portion of the panel that is positioned directly within the crotch region may further comprise an hour-glass shaped upper layer. The upper layer is narrower than the lower layer in the crotch region to help prevent fluid that comes in contact with the upper layer from leaking transversely to the sides of the absorbent article or undergarment. Instead, the upper layer collects the fluid and traps the fluid, preventing the fluids from passing through to the lower layer where the fluids may transversely leak through to the leg openings of the garment. The lower layer of the absorbent panel expands the full width of the crotch region.

### BRIEF DESCRIPTION OF THE DRAWINGS

FIG. 1 is a depiction of the apparatus for the fabrication of the nonwoven fabric according to the present invention;

FIG. 2 is a perspective view of a male brief style disposable undergarment according to the present invention;

FIG. 3 is a perspective view of a male bikini style disposable undergarment according to the present invention;

FIG. 4 is a perspective view of a female brief style disposable undergarment according to the present invention;

FIG. 5 is a perspective view of a female bikini style disposable undergarment according to the present invention;

FIGS. 6 and 7 are perspective views of a male sport brief style disposable undergarment according to the present invention;

FIG. 8 a plan view of a diaper 20 in an uncontracted state;

FIG. 9 is a side view of the absorbent panel construct embodying the principles of the present invention; and

FIG. 10 is a front view of the absorbent panel construct of the present invention.

### DETAILED DESCRIPTION OF THE INVENTION

While the present invention is susceptible of embodiment in various forms, hereinafter is described presently preferred embodiments of the invention, with the understanding that the present disclosure is to be considered as exemplifications of the invention, and is not intended to limit the invention to the specific embodiments illustrated.

The nonwoven fabric of the present invention is formed from natural fibers, synthetic fibers, or a combination of natural and synthetic fibers. The fibers may be of finite staple length, continuous filaments and the blends thereof. Synthetic fibers may be selected from thermoset polymers such as polyacrylates, or from thermoplastic polymers, including; polyamides, polyesters, or polyolefins, such as polypropylene or polyethylene, their derivatives, and combinations thereof. The synthetic fibers of the present invention may also include any fibers with multi-component configurations, such as side-by-side or sheath-core, as well as geometric variations. The natural fibers of the present invention are cellulosic in nature such as cotton, wood pulp, or rayon.

The nonwoven fabric used in accordance with the present invention should be durable and able to withstand the stress of continual body movement involved with everyday activities. The fabric should also have suitable drape and hand properties so that the fabric will conform to the curves of the body. In addition, the fabric should have a hydrophilic and hydrophobic sides in order absorb and repel moisture where needed.

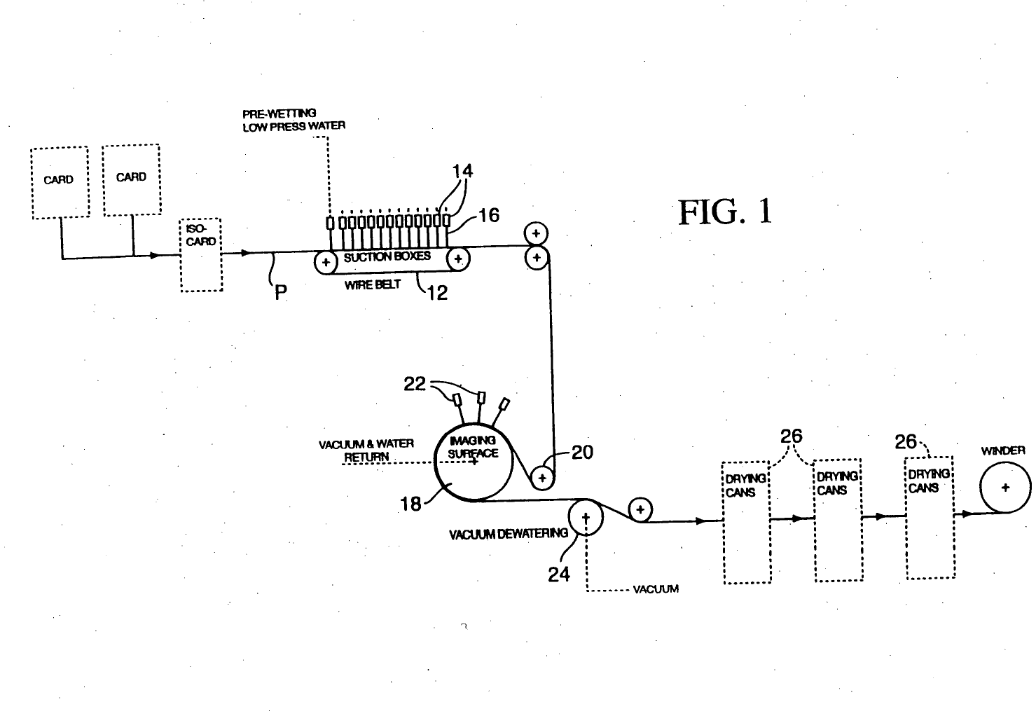

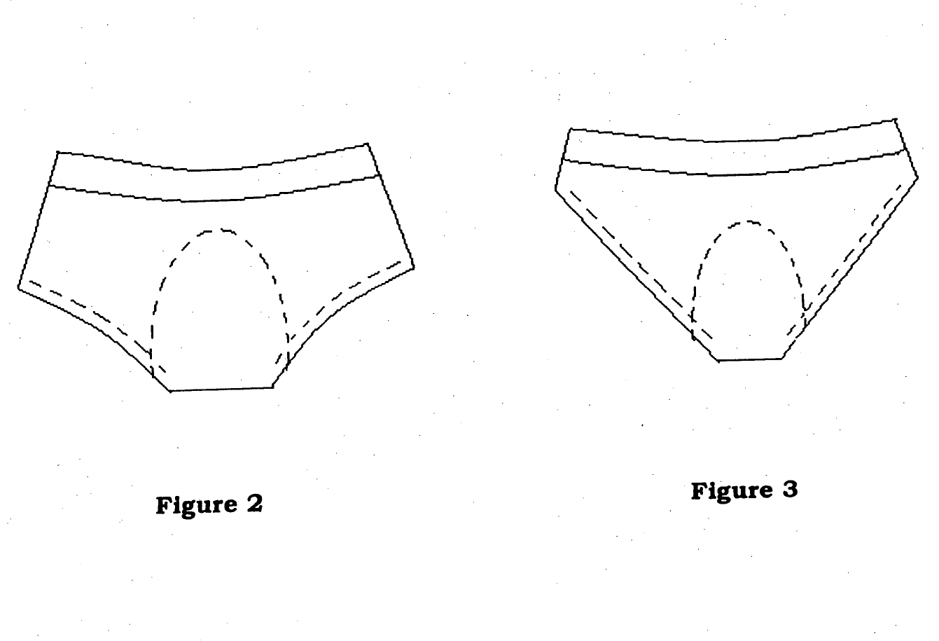

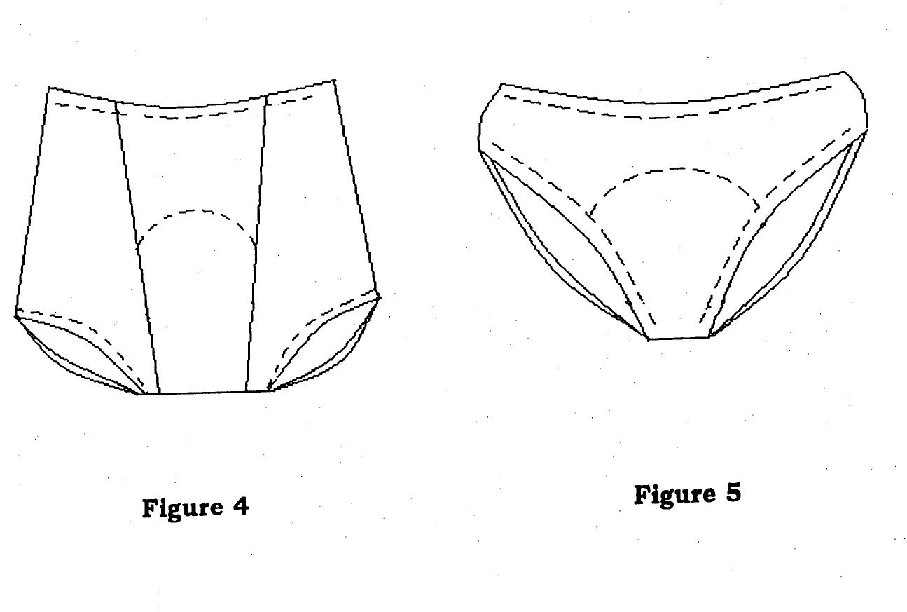

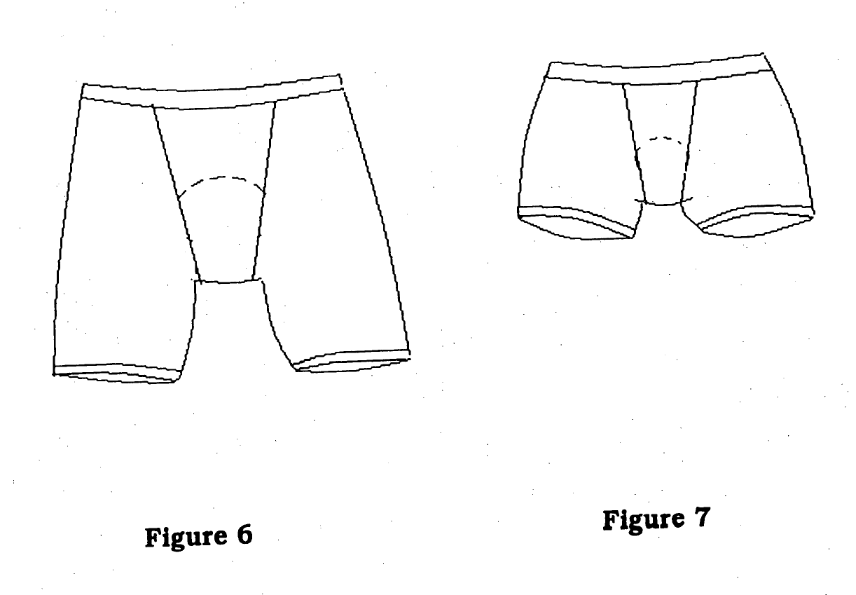

In reference to FIG. 1, therein is illustrated an apparatus for practicing the method of the present invention for forming a nonwoven fabric. The fabric is formed from a fibrous matrix, which comprises fibers selected to promote economical manufacture, while achieving the desired resultant nonwoven fabric. The fibrous matrix is preferably carded and subsequently air-randomized to form a precursor web, designated P.

FIG. 1 illustrates a hydroentangling apparatus for forming nonwoven fabrics in accordance with the present invention. The apparatus includes a foraminous forming surface in the form of a flat bed entangler 12 upon which the precursor web P is positioned for pre-entangling. Precursor web P is then sequentially passed under entangling manifolds 14, whereby the precursor web is subjected to high-pressure water jets 16. This process is well known to those skilled in the art and is generally taught by U.S. Pat. No. 3,485,706, to Evans, hereby incorporated by reference.

The entangling apparatus of FIG. 1 further includes an imaging and patterning drum 18 comprising a three-dimensional image transfer device for effecting imaging and patterning of the now-entangled precursor web. After pre-entangling, the precursor web is trained over a guide roller 20 and directed to the image transfer device 18, where a three-dimensional image is imparted into the fabric on the foraminous forming surface of the device. The web of fibers is juxtaposed to the image transfer device 18, and high pressure water from manifolds 22 is directed against the outwardly facing surface from jet spaced radially outwardly of the image transfer device 18. The image transfer device 18, and manifolds 22, may be formed and operated in accordance with the teachings of commonly assigned U.S. Pat. No. 4,098,764, No. 5,244,711, No. 5,822,823, and No. 5,827,597, the disclosures of which are hereby incorporated by reference. It is presently preferred that the precursor web P be given a three-dimensional image suitable to provide fluid management, as will be further described, to promote use of the present nonwoven fabric in disposable absorbent articles. The entangled fabric can be vacuum dewatered at 24, and dries at an elevated temperature on drying cans 26.

The nonwoven fabric of the present invention may be a composite, laminate, single layer or multiple layers so as to incorporate a support member, such as a scrim and/or absorbent mechanisms, suited for limited urinary containment, into the undergarment. The nonwoven may be imaged, such as with ribs or swirls, etc., apertured, or modified aesthetically through subsequent dyeing, and printing, or by using colored fibers during the manufacturing step, to achieve the affects of the desired nonwoven disposable undergarment. The nonwoven fabric has a preferred basis weight range of 1.5-5.5 ounces per square yard, with a range of 2.0-3.0 ounces per square yard being most preferred.

A disposable nonwoven undergarment has skin health and hygiene benefits. The breathable and moisture absorbing characteristics of the nonwoven fabric utilized in the disposable undergarment provides the skin with a comfortable environment. The nonwoven fabric helps keep the skin oxygenated and dry, which is beneficial for those individuals with an active lifestyle.

The nonwoven disposable undergarment is typically of the representative brief design, wherein the undergarment is specific to gender and end use application. The brief of the present invention may be scaled to various sizes, i.e. small, medium, large, etc, in order to accommodate various body types or forms. In general, the undergarment is comprised of one or more pieces that are preferentially thermally welded, mechanically stitched, or adhesively bonded at the seams. Each undergarment comprises a waist opening at the upper portion of the undergarment and a pair of leg openings at the lower portion of the undergarment. The undergarment may optionally contain an elastic portion around the waist and leg openings.

In a first embodiment, the disposable undergarment comprises a front panel and a back panel, with an interconnecting crotch region, wherein said front, back panel, and an interconnecting crotch region are mechanically secured together at their transverse edges (i.e., the front and back panels are joined to each other at opposite side seams, and the crotch regions of each panel are joined at a bottom seam). Alternatively, the garment may be unitary in construction, having a generally hourglass-shape, with the front and back panel integrally joined with n interconnecting crotch region. The garment is formed by joining the front and back panel to each other at opposite side seams. The nonwoven undergarment contains two elasticized leg openings and an elasticized waist. The imaged nonwoven undergarment consists of 50% polyester and 50% rayon, whereby the nonwoven fabric is of a layered construct, wherein the soft, hydrophilic rayon fabric layer is inside the undergarment against the skin while the hydrophobic, polyester fabric makes up the facing of the undergarment. The disposable undergarment of this embodiment also contains a discrete cellulosic protective panel for moisture management.

In a second embodiment, the disposable undergarment comprises a front panel and a back panel, with an interconnecting crotch region, wherein the crotch region is comprised of an absorbent panel. The absorbent panel has an upper layer and a lower layer that extends from the front panel, through the crotch region, and up the back panel. The edges of the upper and lower layers are mechanically secured as it extends from the front panel to the back panel, except for the portion that extends through the crotch region. As the absorbent panel enters the crotch region of the undergarment, the upper layer is no longer secured to the lower layer, which results in a distinct separation zone between the two layers that extends the length of the crotch region. Furthermore, the upper layer may optionally become narrower in width, resembling the shape of an hour glass, while the lower layer may remain the full width of the crotch region. The aforementioned upper and lower layer construct of the crotch region helps prevent human exudates from transversely leaking through the leg openings, locking the fluids within the upper layer, thus protecting the lower layer from soiling the outer fabric of the undergarment.

It is within the purview of the present invention to provide medical personnel and patients, male and female athletes, individuals that travel, and individuals with mild incontinence conditions with a comfortable, yet durable nonwoven disposable undergarment. Each disposable undergarment being tailored to the needs of these individuals, but all them having in common a soft feeling, aesthetically pleasing, form-fitting quality that is currently unavailable in disposable undergarments.

The absorbent panel construct of the invention is comprised of an upper layer and lower layer, wherein the two layers may be comprised of a nonwoven fabric, including, but not limited to a continuous filament web, carded staple fiber web, film, and a combination thereof. The nonwoven fabric of the present invention may be a composite, laminate, single layer or multiple layers in order to incorporate support and/or absorbent mechanisms into the absorbent panel construct. The absorbent panel construct can be incorporated in an undergarment as disclosed hereinabove.

The nonwoven fabric of the present invention may be formed from natural fibers, synthetic fibers, or a combination of natural and synthetic fibers. The fibers may be of finite staple length, continuous filaments and the blends thereof. Synthetic fibers may be selected from thermoset polymers such as polyacrylates, or from thermoplastic polymers, including; polyamides, polyesters, or polyolefins, such as polypropylene or polyethylene, their derivatives, and combinations thereof. The synthetic fibers of the present invention may also include any fibers with multi-component configurations, such as side-by -side or sheath-core, as well as geometric or profiled variations, including fibers represented in U.S. Pat. No. 5,977,429, hereby incorporated by reference. The natural fibers of the present invention are cellulosic in nature such as cotton, wood pulp, or rayon.

Further, the nonwoven fabric may be imaged on a three-dimensional image transfer device so as to impart aesthetic to either the upper layer, lower layer, or both layers of the absorbent panel of the present invention.

Optionally, a continuous filament fabric may be incorporated into the absorbent panel construct. In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

Spunbond fabrics suitable for use in the present invention include fine denier, micro-denier, as well as nano-denier filaments. Suitable nano-denier continuous filament barrier layers can be formed by either direct spinning of nano-denier filaments or by formation of a multi-component filament that is divided into nano-denier filaments prior to deposition on a substrate layer. U.S. Pat. Nos. 5,678,379 and No. 6,114,017, both incorporated herein by reference, exemplify direct spinning processes practicable in support of the present invention.

Additionally, films may be incorporated into the present invention. The formation of finite thickness films from thermoplastic polymers, suitable as a strong and durable substrate layer, is a well-known practice. Thermoplastic films may include melt additives to lend to the softness of the film and are often preferred over nonwovens in topsheets of absorbent articles. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed material, or dispensed directly onto a secondary substrate material to form a composite material having performance of both the substrate and the film layers. Examples of suitable secondary substrate materials include other films, polymeric or metallic sheet stock, and woven or nonwoven fabrics.

Extruded films utilizing the composition of the present invention can be formed in accordance with the following representative direct extrusion film process. Blending and dosing storage comprising at least one hopper loader for thermoplastic polymer chip and, optionally, one for pelletized additive in thermoplastic carrier resin, feed into variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the additive into the thermoplastic polymer. The polymer chip and additive pellet blend feeds into a multi-zone extruder. Upon mixing and extrusion from the multi-zone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

Breathable or otherwise apertured films can also be combined with similar or dissimilar film and nonwoven substrates of the present invention. Monolithic films, as taught in U.S. Pat. No. 6,191,211, microporous films, as taught in U.S. Pat. No. 6,264,864, and reticulated films, as taught in U.S. Pat. No. 4,381,326, all of which are herein incorporated by reference, represent the mechanisms of forming such breathable or apertured films.

It is also with in the purview of the present invention to either incorporate a melt additive to the film or nonwoven substrate, topically apply an additive, or utilize a combination of both. Such additives may include, but are not limited to skin enhancing emollients, absorbency enhancing additives, wetting agents, fragrances, pigments, and softening additives.

In accordance with the present invention, the absorbent panel construct is comprised of an upper layer and a lower layer. Each layer has two longitudinal edges, as well as two transverse edges. The two layers can be further described as having a front region, a back region, and two side regions. Further, the upper and lower layers are mechanically secured along the edges of the front and back regions, as well as at least 50% secured along the edges of the two side regions from front region to back region so as to form a distinct separation zone. Preferably, the two side regions of the upper and lower layers are at least 35% secured along the edges, and more preferably, the two side regions are at least 20% secured along the edges.

In one embodiment, the absorbent panel may be utilized as part of an overall absorbent article or undergarment. For instance, the absorbent panel may be utilized as a topsheet for a disposable hygiene article, such as a diaper, incontinence device, sanitary napkin, or the like.

Disposable waste-containment garments, are generally described in U.S. Pat. No. 4,573,986, No. 5,843,056, and No. 6,198,018, which are incorporated herein by reference.

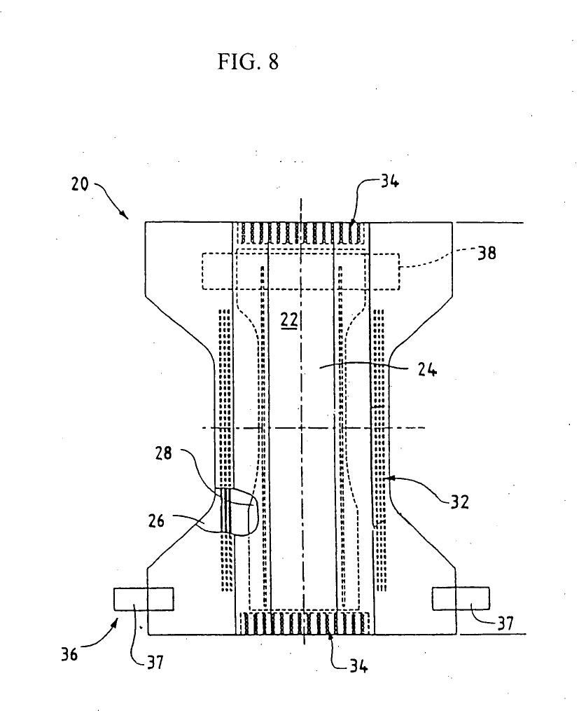

An absorbent article incorporating the absorbent panel construct of the present invention is represented by the unitary disposable absorbent article, diaper 20, shown in FIG. 8. As used herein, the term “diaper” refers to an absorbent article generally worn by infants and incontinent persons that is worn about the lower torso of the wearer. It should be understood, however, that the present invention is also applicable to other absorbent articles such as incontinence briefs, incontinence undergarments, diaper holders and liners, feminine hygiene garments, training pants, pull-on garments, and the like.

FIG. 8 is a plan view of a diaper 20 in an uncontracted state (i.e., with elastic induced contraction pulled out) with portions of the structure being cut-away to more clearly show the construction of the diaper 20. As shown in FIG. 8, the diaper 20 preferably comprises a containment assembly 22 comprising a liquid pervious topsheet 24; a liquid impervious backsheet 26 joined to the topsheet; and an absorbent core 28 positioned between the topsheet 24 and the backsheet 26. The absorbent core 28 has a pair of opposing longitudinal edges, an inner surface and an outer surface. The diaper can further comprise elastic leg features 32; elastic waist features 34; and a fastening system 36 which preferably comprises a pair of securement members 37 and a landing member 38.

In a further embodiment, the absorbent panel construct may be a performance enhancing element for a standard undergarment, such as a woven, cotton brief. In this method of use, the absorbent panel is temporarily affixed to the crotch region of the undergarment preferably by adhesive means so as to enhance the absorbency of the undergarment. The absorbent panel may be disposed of after use and replaced as necessary.

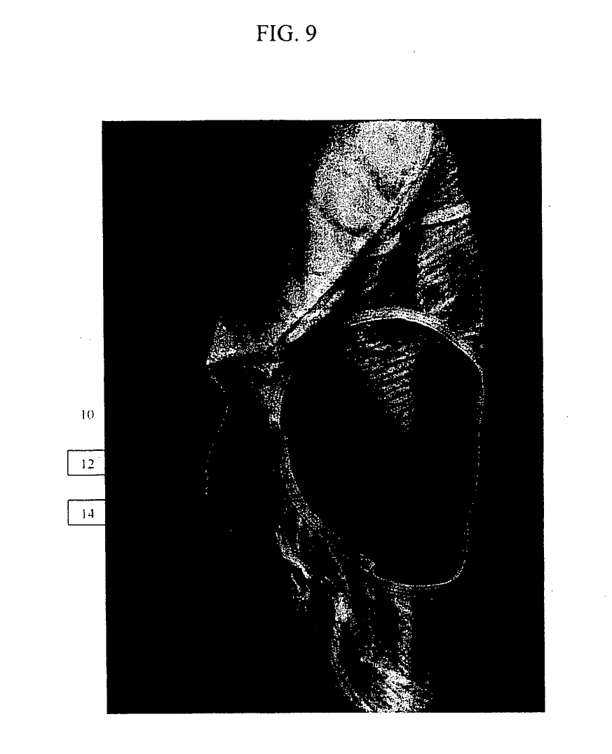

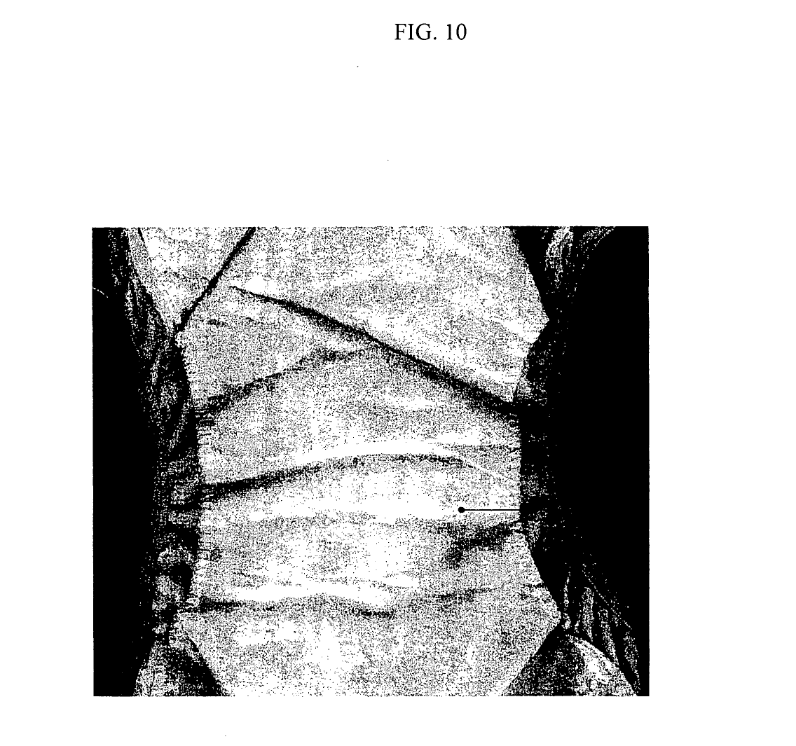

FIG. 9 is a side view of the absorbent panel construct, while FIG. 10 is a frontal view of the absorbent panel that embodies the principles of the present invention. FIGS. 9 and 10 illustrate the absorbent panel as part of the overall structure of a disposable absorbent article. Further, FIG. 9 illustrates the upper layer 10, which is suspended above the lower layer14 so as to form a distinct zone of separation 12.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A process for fabricating a disposable nonwoven undergarment comprising:
a. providing a precursor nonwoven web;
b. providing a foraminous surface;
c. hydroentangling said precursor web on said foraminous surface to form a patterned and imaged nonwoven fabric;
d. forming said patterned and imaged nonwoven fabric into a front panel, a back panel, and crotch region; and
e. joining said front panel, back panel, and crotch region at seams to form a disposable undergarment.

2. A process for fabricating a disposable nonwoven undergarment as in claim 1, wherein said precursor web is a fibrous blend of synthetic and natural fibers.

3. A process for fabricating a disposable nonwoven undergarment as in claim 2, wherein said synthetic fibers are selected from thermoset polymers such as polyacrylates or thermoplastic polymers, including; polyamides, polyesters, or polyolefins, such as polypropylene or polyethylene, their derivatives, and combinations thereof.

4. A process for fabricating a disposable nonwoven undergarment as in claim 3, wherein said synthetic fibers are polyester.

5. A process for fabricating a disposable nonwoven undergarment as in claim 2, wherein said natural fibers are cellulosic in nature such as cotton, wood pulp, or rayon.

6. A process for fabricating a disposable nonwoven undergarment as in claim 5, wherein said natural fibers are rayon.

7. A process for fabricating a disposable nonwoven undergarment as in claim 1, wherein said foraminous surface is a three-dimensional image transfer device.

8. A process for fabricating a disposable nonwoven undergarment as in claim 1, wherein said disposable nonwoven undergarment is imparted with a pattern or three-dimensional image, such as ribs, swirls, etc., by means of a three-dimensional image transfer device.

9. A process for fabricating a disposable nonwoven undergarment as in claim 1, wherein said formed disposable nonwoven undergarment is comprised of one patterned or imaged nonwoven fabric piece.

10. A process for fabricating a disposable nonwoven undergarment as in claim 7, wherein said patterned or imaged nonwoven fabric pieces are joined by thermally welded, mechanically stitched, or adhesively bonded.

11. A process for fabricating a disposable nonwoven undergarment as in claim 8, wherein said pieces are mechanically stitched.

12. A process for fabricating a disposable nonwoven undergarment as in claim 1, wherein said undergarment is for daily use, travelers, or athlete.

13. A process for fabricating a disposable nonwoven undergarment as in claim 1, wherein said undergarment comprises a moisture absorbent panel for mild incontinence purposes.

14. A process for fabricating a disposable nonwoven undergarment as in claim 7, wherein said formed disposable nonwoven undergarment piece comprises elastically lined leg openings and waist opening.

15. A process for fabricating a disposable nonwoven undergarment in accordance with claim 1, wherein said front panel and said back panel are formed unitarily with said crotch region.

16. A process for fabricating a disposable nonwoven undergarment in accordance with claim 1, wherein said front panel and said back panel are formed separately and are joined to each other at said side seams, and at a bottom seam at said crotch region.

17. A disposable nonwoven undergarment hydroentangled on a foraminous surface comprising a front panel, back panel, and an interconnecting crotch region, wherein said front panel, back panel, and interconnecting crotch region are mechanically secured together at their transverse edges forming an upper waist and lower leg regions.

18. A disposable nonwoven undergarment as in claim 17, wherein said upper waist and lower regions comprise an elastic portion.

19. A disposable nonwoven undergarment as in claim 17, and an interconnecting crotch region comprising an absorbent mechanism.

20. A disposable nonwoven undergarment as in claim 19, wherein said absorbent mechanism comprises an upper layer and lower layer within said crotch region that forms a distinct separation zone between said upper and lower layer.

21. A disposable nonwoven undergarment hydroentangled on a foraminous surface comprising a unitary hourglass-shape construct, wherein the front panel and back panel are integrally joined with an interconnecting crotch region and mechanically secured together at their transverse edges forming an upper waist and lower leg regions.

22. A disposable nonwoven undergarment as in claim 21, wherein said upper waist and lower regions comprise an elastic portion.

23. A disposable nonwoven undergarment as in claim 21, said crotch region comprising an absorbent mechanism.

24. A disposable nonwoven undergarment as in claim 21, wherein said upper waist and lower regions comprise an elastic portion.

25. A disposable nonwoven undergarment in accordance with claim 22, including:
an absorbent panel construct in said crotch region comprising an upper layer and a lower layer, wherein said upper and lower layers are comprised of a front region, a back region, and two side regions, said layers being mechanically secured along said front region, back region, and at least 50% secured along said side regions of said panel construct, whereby a portion of said side regions of said layers remain essentially unattached to form a distinct zone of separation.

26. An absorbent panel construct for use in an absorbent article to prevent human exudates from transversely leaking through the sides of said absorbent article comprising an upper layer and lower layer, wherein said upper and lower layers are comprised of a front region, a back region, and two side regions; said layers mechanically secured along said front region, back region, and at least 50% secured along said side regions of said panel, whereby a portion of said side regions of said upper and lower layers remain essentially unattached to form a distinct zone a separation.

27. An absorbent panel construct for use in an absorbent article to prevent human exudates from transversely leaking through the sides of said absorbent article as in claim 26, wherein said upper layer is hour-glass shaped.

28. An absorbent panel construct for use in an absorbent article to prevent human exudates from transversely leaking through the sides of said absorbent article as in claim 26, wherein said upper layer is a nonwoven substrate, film substrate, or combination thereof.

29. An absorbent panel construct for use in an absorbent article to prevent human exudates from transversely leaking through the sides of said absorbent article as in claim 26, wherein said lower layer is a nonwoven substrate, film substrate, or combination thereof.

30. An absorbent panel construct for use in an absorbent article to prevent human exudates from transversely leaking through the sides of said absorbent article as in claim 26, wherein said absorbent panel is a topsheet within a disposable absorbent article.

31. An absorbent panel construct for use in an undergarment to prevent human exudates from transversely leaking through the sides of said absorbent article comprising an upper layer and lower layer, wherein said upper and lower layers are comprised of a front region, a back region, and two side regions; said layers mechanically secured along said front region, back region, and at least 50% along said side regions of said panel, whereby a portion of said side regions of said upper and lower layers remain essentially unattached to form a distinct zone a separation.
